(19) United States
(12) Patent Application Publication
(10) Pub. No.: US 2020/0252781 A1
(43) Pub. Date: Aug. 6, 2020

(54) SYSTEMS AND METHODS FOR SUPPORTING LOCATION BASED ROUTING OF EMERGENCY SERVICES CALLS

(71) Applicant: QUALCOMM Incorporated, San Diego, CA (US)

(72) Inventor: Stephen William EDGE, Escondido, CA (US)

(21) Appl. No.: 16/780,227

(22) Filed: Feb. 3, 2020

Related U.S. Application Data
(60) Provisional application No. 62/801,083, filed on Feb. 4, 2019.

(51) Int. Cl. H04W 4/90; H04W 4/029

(52) U.S. Cl. CPC H04W 4/90; H04W 4/029

(57) ABSTRACT

A network entity in a wireless network supports routing of an emergency call for a user equipment (UE) to a Public Safety Answering Point (PSAP) based on determining whether Location Based Routing (LBR) is needed according to the serving cell for the UE. LBR may be needed when multiple PSAPs have jurisdiction over the serving cell coverage area, in which case an early location fix, based on early location information from the UE (e.g. obtained using LPP), and a later final location fix may be obtained. The early location fix is used to perform LBR to an appropriate PSAP. The final location fix is more accurate and is provided later to the PSAP for emergency dispatch. If LBR is not needed, the serving cell identity may be used to route the call to the PSAP instead of an early location fix, which can reduce latency.

### CROSS-REFERENCE TO RELATED APPLICATIONS

This application claims the benefit of U.S. Provisional Application No. 62/801,083, entitled “LOCATION BASED ROUTING FOR E911 CALLS USING AN LPP EARLY LOCATION FIX,” filed Feb. 4, 2019, which is assigned to the assignee hereof and which is expressly incorporated herein by reference in its entirety.

### BACKGROUND

### Field

The present disclosure relates generally to communication, and more specifically to techniques for supporting location based routing for a user equipment (UE) during an emergency call.

### Relevant Background

Wireless communication networks are widely deployed to provide various communication services such as voice, video, packet data, messaging, broadcast, and so on. A user may place an emergency call (e.g. an E911 call in the United States) with a wireless network, which requires routing of the emergency call to a Public Safety Answering Point (PSAP) whose service area includes the current location of the user. This may require routing of the emergency call based on the current user location.

Thus, there is a need for techniques to support location based routing services during emergency calls.

### SUMMARY

A network entity in a wireless network supports routing of an emergency call for a user equipment (UE) to a Public Safety Answering Point (PSAP) based on determining whether Location Based Routing (LBR) is needed according to the serving cell for the UE. LBR may be needed when multiple PSAPs have jurisdiction over the serving cell coverage area, in which case an early location fix, based on early location information from the UE (e.g. obtained using LPP), and a later final location fix may be obtained. The early location fix is used to perform LBR to an appropriate PSAP. The final location fix is more accurate and is provided later to the PSAP for emergency dispatch. If LBR is not needed, the serving cell identity may be used to route the call to the PSAP instead of an early location fix, which can reduce latency.

In one implementation, a network entity configured for supporting location based routing (LBR) of an emergency call for a user equipment (UE) to a Public Safety Answering Point (PSAP), the network entity being a first network entity in a wireless network, includes an external interface configured to wirelessly communicate with other entities in the wireless network; at least one memory; at least one processor coupled to the external interface and the at least one memory, wherein the at least one processor is configured to: obtain an indication of whether the emergency call requires LBR, the indication based on a serving cell for the UE; obtain a first location estimate for the UE when the indication indicates the emergency call requires LBR, the first location estimate being more accurate than a location based on the serving cell, the first location estimate enabling LBR, the first location estimate obtained within a first response time; and obtain a second location estimate for the UE for delivery to the PSAP, the second location estimate obtained within a second response time, wherein the second location estimate is more accurate than the first location estimate, wherein the second response time exceeds the first response time.

In one implementation, a network entity configured for supporting location based routing (LBR) of an emergency call for a user equipment (UE) to a Public Safety Answering Point (PSAP), includes means for obtaining an indication of whether the emergency call requires LBR, the indication based on a serving cell for the UE; means for obtaining a first location estimate for the UE when the indication indicates the emergency call requires LBR, the first location estimate being more accurate than a location based on the serving cell, the first location estimate enabling LBR, the first location estimate obtained within a first response time; and means for obtaining a second location estimate for the UE for delivery to the PSAP, the second location estimate obtained within a second response time, wherein the second location estimate is more accurate than the first location estimate, wherein the second response time exceeds the first response time.

In one implementation, a non-transitory storage medium including program code stored thereon, the program code is operable to cause at least one processor in network entity in a wireless network to support location based routing (LBR) of an emergency call for a user equipment (UE) to a Public Safety Answering Point (PSAP), includes program code to obtain an indication of whether the emergency call requires LBR, the indication based on a serving cell for the UE; program code to obtain a first location estimate for the UE when the indication indicates the emergency call requires LBR, the first location estimate being more accurate than a location based on the serving cell, the first location estimate enabling LBR, the first location estimate obtained within a first response time; and program code to obtain a second location estimate for the UE for delivery to the PSAP, the second location estimate obtained within a second response time, wherein the second location estimate is more accurate than the first location estimate, wherein the second response time exceeds the first response time.

### BRIEF DESCRIPTION OF THE DRAWINGS

An understanding of the nature and advantages of various embodiments may be realized by reference to the following figures.

FIG. 1 is a simplified block diagram illustrating a network architecture capable of supporting Location Based Routing (LBR) of an emergency call for a user equipment (UE) to a Public Safety Answering Point (PSAP).

FIG. 2 illustrates a geographic region that includes a number of network cells and the coverage areas of a number of PSAPs.

FIG. 3 shows a message flow illustrating how various components of a wireless communication system can establish an IMS emergency call using LBR.

FIG. 4A shows a message flow illustrating establishment of an IMS emergency call using LBR with a control plane location solution.

FIG. 4B shows a message flow illustrating establishment of an IMS emergency call using LBR with a user plane location solution.

FIG. 5 shows a process flow illustrating a method of supporting LBR of an emergency call for a UE to a PSAP.

FIG. 6 is a block diagram of an embodiment of a network entity capable of supporting LBR of an emergency call for a UE to a PSAP.

Like reference numbers and symbols in the various figures indicate like elements, in accordance with certain example implementations. In addition, multiple instances of an element may be indicated by following a first number for the element with a hyphen and a letter. For example, multiple instances of an element 160 may be indicated as 160-a, 160-b etc. When referring to such an element using only the first number, any instance of the element is to be understood (e.g. element 160 may refer to element 160-a and/or 160b).

### DETAILED DESCRIPTION

With location based routing (LBR) of a wireless emergency call, an emergency call from a UE (e.g. an E911 call dialed in the US) would be routed to a Public Safety Answering Point (PSAP) which is determined according to the location of the UE. Solutions to support LBR (e.g. solutions evaluated by the Alliance for Telecommunications Industry Solutions (ATIS) in the US) can require architectural change to wireless networks and/or may depend on proprietary location solutions defined by particular network or UE vendors. In addition, some of these solutions may have a location response time that is too high to be usable for an emergency call, which would typically need to be routed to a PSAP within around 3-5 seconds of the call being instigated by a user. Consequently, solutions to support LBR for wireless emergency calls that do not require architectural change, that use a standards based location solution, and that can deliver a location within 3-5 seconds would be desirable.

As described below, one solution to support LBR of wireless E911 calls is based on use of an early location fix for the Long Term Evolution (LTE) Positioning Protocol (LPP), which allows a location server (e.g. an E-SMLC) to request an early location fix from a UE followed by a later final location fix. This LPP capability can be used to support LBR using an enhancement to the current 3GPP control plane solution for emergency calls over LTE. With this solution, signaling procedures inside a network are modified to transport both an early location fix and a later final location fix to a Location Retrieval Function (LRF) (e.g. in an IP Multimedia Subsystem (IMS) of a serving network), which can enable support of LBR and a more accurate location for PSAP dispatch. The modifications to existing signaling procedures to support this solution may have less impact to a network operator than alternative proprietary solutions such as those evaluated by ATIS.

In addition, another solution, described below, is to identify network cells in a database for which LBR is not needed. A UE served by a network cell that is in the interior region of a PSAP coverage area should always have an emergency call routed to the same PSAP, which does not depend on the exact location of the UE within the coverage area of the network cell. Accordingly, an emergency call originating in such a network cell may be identified and routed to the appropriate PSAP based on the serving cell identity (ID), thereby avoiding any extra delay for LBR. Thus, the extra delay caused by LBR may affect only a small proportion of emergency calls made by UEs accessing cells whose coverage areas include, or are near to, the periphery of a PSAP coverage area.

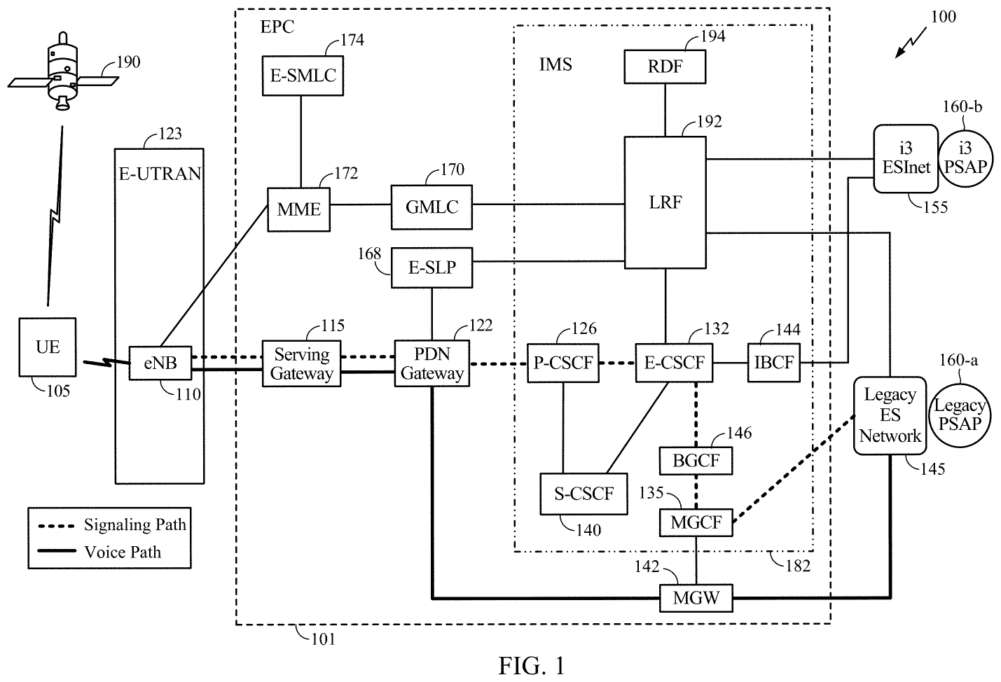

FIG. 1 is a block diagram illustrating a Long Term Evolution (LTE) or LTE-Advanced network architecture of a wireless communications system 100. Wireless communications system 100 may be applicable to an emergency call over IMS. Among other components, the system includes a UE 105, an LTE core network (also referred to as an Evolved Packet Core (EPC)) 101, an Evolved Universal Terrestrial Radio Access Network (E-UTRAN) 123, a Legacy Emergency Services (ES) Network 145 with a Legacy PSAP 160-a, and a National Emergency Number Association (NENA) i3 Emergency Services IP network (ESInet) 155 with a NENA i3 capable PSAP 160-b. The E-UTRAN 123 may include an Evolved Node B (eNodeB, or eNB) 110. Although only one eNB 110 is shown in FIG. 1, E-UTRAN 123 may include many eNBs 110 (e.g., hundreds or thousands). EPC 101 may include a Serving Gateway (S-GW) 115, a Packet Data Network (PDN) Gateway (PDN-GW) 122, an Emergency Secure User Plane Location (SUPL) Location Platform (E-SLP) 168, a Gateway Mobile Location Center (GMLC) 170, a Mobility Management Entity (MME) 172, an Enhanced Serving Mobile Location Center (E-SMLC) 174, and a Media Gateway (MGW) 142. EPC 101 may include, or be connected to, an IP Multimedia Subsystem (IMS) 182 that may include a Proxy Call Session Control Function (P-CSCF) 126, an Emergency Call Session Control Function (E-CSCF) 132, a Serving Call Session Control Function (S-CSCF) 140, an Interconnection Border Control Function (IBCF) 144, a Location Retrieval Function (LRF) 192, a Routing Determination Function (RDF) 194, a Breakout Gateway Control Function (BGCF) 146, and a Media Gateway Control Function (MGCF) 135 that is connected to the MGW 142. In some aspects, the MGCF 135 may be incorporated into or otherwise joined with the MGW 142. In other aspects, such as the example shown in FIG. 1, they may be separately implemented and/or maintained. Other aspects may add, omit, join, separate, rearrange, or otherwise alter components depending on desired functionality. Such variations will be recognized by a person of ordinary skill in the art.

In an aspect, EPC 101 combined with E-UTRAN 123 in FIG. 1 may correspond to a visited network or a home network for a UE 105. EPC 101 combined with E-UTRAN 123 may be referred to as an Evolved Packet System (EPS).

The eNB 110 may be a serving eNB for the UE 105 and may provide wireless communications access to the EPC 101 on behalf of UE 105. The MME 172 may be a serving MME for the UE 105 and may support mobility of UE 105 and provision of signaling access and voice bearer paths. The serving gateway 115 and PDN gateway 122 may provide IP based signaling and IP transport support for UE 105—e.g., with PDN gateway 122 assigning an IP address for UE 105 and providing IP access to other entities in EPC 101, such MGW 142, E-SLP 168 and P-CSCF 126.

In one aspect, IMS 182 may be part of EPC 101, as shown in FIG. 1. In another aspect, however, IMS 182 may not be part of EPC 101 (not shown in FIG. 1). IMS 182 may support an IMS emergency call from UE 105 to a PSAP, such as i3 PSAP 160-b or legacy PSAP 160-a. For example, in the case of an IMS emergency call from UE 105 to i3 PSAP 160-b, a signaling path (not shown in FIG. 1) from UE 105 may pass through the eNB 110, serving gateway 115, PDN gateway 122, P-CSCF 126, E-CSCF 132, IBCF 144, the i3 ESInet 155, and i3 PSAP 160-b. In the case of an IMS emergency call from UE 105 to legacy PSAP 160-a, a signaling path from UE 105 (shown in FIG. 1 by the dashed bolded line) may pass through the eNB 110, serving gateway 115, PDN gateway 122, P-CSCF 126, E-CSCF 132, BGCF 146, MGCF 135, the legacy ES Network 145, and legacy PSAP 160-a.

Elements in IMS 182 may provide call handling and call routing support to enable an IMS emergency call from UE 105 to either i3 PSAP 160-b or legacy PSAP 160-a. For example, P-CSCF 126 may detect an IMS emergency call when instigated by UE 105 (e.g., by receiving, decoding, and interpreting a Session Initiation Protocol (SIP) INVITE message sent by UE 105). E-CSCF 132 may support routing of an IMS emergency call from UE 105 (e.g., by sending a SIP INVITE from UE 105 received via P-CSCF 126 towards either legacy PSAP 160-a via MGCF 135 or i3 PSAP 160-b via an IBCF 144). The S-CSCF 140 may support incoming and outgoing IMS non-emergency calls for UE 105 and, in some instances, may support IMS emergency calls for UE 105. Location Retrieval Function (LRF) 192 may assist routing of an IMS emergency call from UE 105 when queried by E-CSCF 132. For example, LRF 192 may determine a location for UE 105 (e.g., from information provided by UE 105 in a SIP INVITE) and may determine a PSAP (e.g., legacy PSAP 160-a or i3 PSAP 160-b) that supports a CS emergency call or an IMS emergency call for that location and may return an identity or address for this PSAP to E-CSCF 132. LRF 192 may also provide the location of a UE 105 which instigates an IMS emergency call to a PSAP 160 by receiving a location request from the PSAP 160 for the UE 105 and obtaining and returning a location of the UE 105 to the PSAP 160. MGCF 135 may perform conversion of SIP based signaling, received from or sent to UE 105, to or from signaling used by the legacy ES network 145, such as ISDN (Integrated Services Digital Network) User Part (ISUP) signaling in the case of an IMS emergency call to legacy PSAP 160-a. For example, MGCF 135 may partly convert an IMS emergency call received from UE 105 into a CS emergency call in the case of an IMS emergency call routed to legacy PSAP 160-a.

I3 ESInet 155 may support IP based emergency calls including an IMS emergency call from UE 105 on behalf of i3 PSAP 160-b—e.g., may route an IMS emergency call from UE 105 to i3 PSAP 160-b. Legacy ES network 145 may similarly support CS-based emergency calls on behalf of legacy PSAP 160-a, including a CS emergency call received via MGCF 135 from UE 105—e.g., may route a CS emergency call from UE 105 received via MGCF 135 to legacy PSAP 160-a. MGW 142 may convert between Voice over IP (VoIP) data received from or sent to UE 105 and CS-based voice data sent to or received from legacy PSAP 160-a in the case of an IMS emergency call from UE 105 to legacy PSAP 160-a.

In the case of an IMS emergency call from UE 105 to legacy PSAP 160-a, the signaling path from the UE 105 to the legacy PSAP 160-a, marked with a dashed bolded line, communicatively connects the UE 105 with the legacy PSAP 160-a and may be used to transfer signaling messages (e.g., SIP messages, ISUP messages) and/or other signals (e.g., multi-frequency (MF) tones). This path includes the following chain of elements: UE 105, eNB 110, Serving Gateway 115, PDN Gateway 122, P-CSCF 126, E-CSCF 132, MGCF 135, legacy ES Network 145, and legacy PSAP 160-a. The voice path (also referred to as a voice media path, media path, data path, voice channel, audio channel, audio path) for an IMS emergency call from the UE 105 to the legacy PSAP 160-a, marked with a solid bolded line, communicatively connects the UE with the legacy PSAP 160-a. This path includes the following chain of components: UE 105, eNB 110, Serving Gateway 115, PDN Gateway 122, MGW 142, legacy ES Network 145, and legacy PSAP 160-a. Communication of signaling (e.g., SIP messages) from the UE 105 to the MGCF 135 is typically packet switched (e.g., SIP transported using Transmission Control Protocol (TCP) or User Datagram Protocol (UDP) over IP), while communication of signaling from the MGCF 135 to the legacy PSAP 160-a may be based on Signaling System number 7 (SS7) (e.g., ISUP) and/or may use in-band MF signaling, although aspects may vary. Communication of voice from the UE 105 to the MGW 142 is typically packet switched (e.g., Voice over LTE (VoLTE) and/or VoIP), while communication of voice from the MGW 142 to the legacy PSAP 160-a is circuit switched (e.g., Pulse Code Modulation (PCM) A-law, PCM μ-law), although aspects may vary.

The eNB 110 is connected by an interface (e.g. the 3GPP S1 interface) to the MME 172 and Serving Gateway 115. The MME 172 may be the serving MME for UE 105 and is then the control node that processes the signaling between the UE 105 and the EPC 101 and supports attachment and network connection of UE 105, mobility of UE 105 (e.g. via handover between network cells) as well as establishing and releasing voice and data bearers on behalf of the UE 105. Generally, the MME 172 provides bearer and connection management for the UE 105 and may be connected to the eNB 110, the E-SMLC 174 and the GMLC 170 in the EPC 101.

The E-SMLC 174 may support location of the UE 105 using the 3GPP control plane (CP) location solution defined in 3GPP technical specifications (TSs) 23.271 and 36.305. The GMLC 170 may provide access on behalf of a PSAP 160-a or 160-b to the location of UE 105 via the LRF 192.

The UE 105 may be any electronic device configured for emergency calls using radio access. While FIG. 1 illustrates an LTE based network, similar network implementations and configurations may be used for other communication technologies, such as 3G, 5G, 802.11 WiFi etc. The UE 105 may be referred to as a device, a wireless device, a mobile terminal, a terminal, a mobile station (MS), a mobile device, a Secure User Plane Location (SUPL) Enabled Terminal (SET) or by some other name and may correspond to (or be part of) a smart watch, digital glasses, fitness monitor, smart car, smart appliance, cellphone, smartphone, laptop, tablet, PDA, tracking device, control device, or some other portable or moveable device. A UE 105 may comprise a single entity or may comprise multiple entities such as in a personal area network where a user may employ audio, video and/or data I/O devices and/or body sensors and a separate wireline or wireless modem. Typically, though not necessarily, a UE 105 may support wireless communication with one or more types of Wireless Wide Area Network (WWAN) such as a WWAN supporting Global System for Mobile Communications (GSM), Code Division Multiple Access (CDMA), Wideband CDMA (WCDMA), Long Term Evolution (LTE), Narrow Band Internet of Things (NB-IoT), Enhanced Machine Type Communications (eMTC) also referred to as LTE category M1 (LTE-M), High Rate Packet Data (HRPD), WiMax, Fifth Generation (5G) New Radio (NR), etc. A UE 105 may also support wireless communication with one or more types of Wireless Local Area Network (WLAN) such as a WLAN supporting IEEE 802.11 WiFi or Bluetooth® (BT). UE 105 may also support communication with one or more types of wireline network such as by using a Digital Subscriber Line (DSL) or packet cable for example. Although FIG. 1 shows only one UE 105, there may be many other UEs that can each correspond to UE 105.

In particular implementations, the UE 105 may have circuitry and processing resources capable of obtaining location related measurements (also referred to as location measurements), such as measurements for signals received from GPS or other Satellite Positioning System (SPS) space vehicles (SVs) 190, measurements for cellular transceivers such as eNB 110, and/or measurements for local transceivers. UE 105 may further have circuitry and processing resources capable of computing a position fix or estimated location of UE 105 based on these location related measurements. In some implementations, location related measurements obtained by UE 105 may be transferred to a location server, such as the E-SMLC 174, after which the location server may estimate or determine a location for UE 105 based on the measurements.

Location related measurements obtained by UE 105 may include measurements of signals received from SVs 190 belonging to an SPS or Global Navigation Satellite System (GNSS) such as GPS, GLONASS, Galileo or Beidou and/or may include measurements of signals received from terrestrial transmitters fixed at known locations (e.g., such as eNB 110, additional eNBs, or other local transceivers). UE 105 or a separate location server (e.g. E-SMLC 174) may then obtain a location estimate for the UE 105 based on these location related measurements using any one of several position methods such as, for example, GNSS, Assisted GNSS (A-GNSS), Advanced Forward Link Trilateration (AFLT), Observed Time Difference Of Arrival (OTDOA), Enhanced Cell ID (ECID), Round Trip signal propagation time (RTT), multi-cell RTT, WiFi, or combinations thereof. In some of these techniques (e.g. A-GNSS, AFLT and OTDOA), pseudoranges or timing differences may be measured by UE 105 relative to three or more terrestrial transmitters fixed at known locations or relative to four or more SVs with accurately known orbital data, or combinations thereof, based at least in part, on pilot signals, positioning reference signals (PRS) or other positioning related signals transmitted by the transmitters or SVs and received at the UE 105.

To facilitate positioning techniques such as A-GNSS, AFLT, OTDOA, multi-cell RTT and ECID, location servers, such as E-SMLC 174, may be capable of providing positioning assistance data to UE 105 including, for example, information regarding signals to be measured by UE 105 (e.g., expected signal timing, signal coding, signal frequencies, signal Doppler), locations and/or identities of terrestrial transmitters, and/or signal, timing and orbital information for GNSS SVs. The facilitation may include improving signal acquisition and measurement accuracy by UE 105 and/or, in some cases, enabling UE 105 to compute its estimated location based on the location measurements. For example, location servers may comprise an almanac (e.g. a Base Station Almanac (BSA)) which indicates the locations and identities of cellular transceivers and transmitters (e.g. eNB 110 and other eNBs) and/or local transceivers and transmitters in a particular region or regions such as a particular venue, and may further contain information descriptive of signals transmitted by these transceivers and transmitters such as signal power, signal timing, signal bandwidth, signal coding and/or signal frequency. In the case of ECID, a UE 105 may obtain measurements of signal strength (e.g. received signal strength indication (RSSI) or reference signal received power (RSRP)) for signals received from cellular transceivers (e.g., eNB 110) and/or local transceivers and/or may obtain a signal to noise ratio (S/N), a reference signal received quality (RSTQ), or an RTT between UE 105 and a cellular transceiver (e.g., eNB 110) or a local transceiver. A UE 105 may transfer these measurements to a location server, such as E-SMLC 174, to determine a location for UE 105, or in some implementations, UE 105 may use these measurements together with assistance data (e.g. terrestrial almanac data or GNSS SV data such as GNSS Almanac and/or GNSS Ephemeris information) received from the location server to determine a location for UE 105.

In the case of OTDOA, UE 105 may measure a Reference Signal Time Difference (RSTD) between signals, such as a Positioning Reference Signal (PRS) or a Cell specific Reference Signal (CRS), received from nearby transceivers or base stations (e.g. eNB 110 and additional eNBs). An RSTD measurement may provide the time of arrival difference between signals (e.g. CRS or PRS) received at UE 105 from two different transceivers (e.g. an RSTD between signals received from eNB 110 and another eNB). The UE 105 may return the measured RSTDs to a location server (e.g. E-SMLC 174) which may compute an estimated location for UE 105 based on known locations and known signal timing for the measured transceivers. In some implementations of OTDOA, the signals used for RSTD measurements (e.g. PRS or CRS signals) may be accurately synchronized by the transceivers or transmitters to a common universal time such as GPS time or coordinated universal time (UTC), e.g., using a GPS receiver at each transceiver or transmitter to accurately obtain the common universal time.

An estimate of a location of a UE 105 may be referred to as a location, location estimate, location fix, fix, position, position estimate or position fix, and may be geodetic, thereby providing location coordinates for the UE 105 (e.g., latitude and longitude) which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of a UE 105 may also include an uncertainty and may then be expressed as an area or volume (defined either geodetically or in civic form) within which the UE 105 is expected to be located with some given or default probability or confidence level (e.g., 67% or 95%). A location of a UE 105 may further be an absolute location (e.g. defined in terms of a latitude, longitude and possibly altitude and/or uncertainty) or may be a relative location comprising, for example, a distance and direction or relative X, Y (and Z) coordinates defined relative to some origin at a known absolute location. In the description contained herein, the use of the term location may comprise any of these variants unless indicated otherwise. Measurements (e.g. obtained by UE 105 or by another entity such as eNB 110) that are used to determine (e.g. calculate) a location estimate for UE 105 may be referred to as measurements, location measurements, location related measurements, positioning measurements or position measurements and the act of determining a location for the UE 105 may be referred to as positioning of the UE 105 or locating the UE 105.

The E-SMLC 174 and the eNB 110 may communicate using an LTE Positioning Protocol A (LPPa) defined in 3GPP Technical Specification (TS) 36.455, with LPPa messages being transferred between the eNB 110 and the E-SMLC 174 via the MME 172. Moreover, E-SMLC 174 and UE 105 may communicate using LPP defined in 3GPP TS 36.355, where LPP messages are transferred between the UE 105 and the E-SMLC 174 via the MME 172 and a serving eNB 110 for UE 105. The LPP protocol may be used to support positioning of UE 105 using UE-assisted and/or UE-based position methods such as A-GNSS, Real Time Kinematic (RTK), OTDOA, multi-cell RTT, and/or ECID. With UE-assisted positioning, UE 105 may obtain location measurements and return the location measurements to E-SMLC 174 for computation of a location estimate for UE 105. With UE-based positioning, UE 105 may obtain location measurements and compute a location estimate from the measurements—e.g. using assistance data provided by E-SMLC 174. The LPPa protocol may be used to support positioning of UE 105 using network based position methods such as ECID (when used with measurements of UE 105 obtained by an eNB 110) and/or may be used by E-SMLC 174 to obtain location related information from eNB 110 such as parameters defining transmission of a positioning reference signal (PRS) for the OTDOA position method from eNB 110.

In some embodiments, LPP messages can be encapsulated in LCS Application Protocol (LCS-AP) messages and in Non-Access Stratum (NAS) messages to be transported between UE 105 and E-SMLC 174. In particular, between the MME 172 and E-SMLC 174, an LPP message may be contained in an LCS-AP message. (e.g. as defined in 3GPP TS 29.171.) Between the MME 172 and eNB 110, an LPP message may be encapsulated in a NAS message which is then contained in an S1 Application Protocol message (e.g. as defined in 3GPP TS 36.413.) Between the UE 105 and eNB 110, the LPP message can be encapsulated in an NAS message which is then contained in a Radio Resource Control (RRC) message.

Information provided by an eNB 110 to the E-SMLC 174 using LPPa may include timing and configuration information for PRS transmission from the eNB 110 and/or location coordinates for the eNB 110. The E-SMLC 174 can then provide some or all of this information to the UE 105 as assistance data in an LPP message via the E-UTRAN 123 and the EPC 101.

An LPP message sent from the E-SMLC 174 to the UE 105 may instruct the UE 105 to do any of a variety of things, depending on desired functionality. For example, the LPP message could contain an instruction for the UE 105 to obtain measurements for GNSS (or A-GNSS), Wireless Local Area Network (WLAN), and/or OTDOA (or some other position method). In the case of OTDOA, the LPP message may instruct the UE 105 to obtain one or more measurements (e.g. RSTD measurements) of PRS signals transmitted within particular cells supported by eNB 110 and/or by other eNBs. The UE 105 may then send the measurements back to the E-SMLC 174 in an LPP message via the serving eNB 110 and the MME 172.

It is noted that the techniques described herein may be applicable to a CP location solution. In a CP location solution, signaling (e.g. including positioning protocol messages such as LPP or LPPa messages) to support location of UE 105 may be transferred between participating entities (e.g. GMLC 170, MME 172, E-SMLC 174, eNB 110 and UE 105) using existing signaling interfaces and protocols for EPC 101 and E-UTRAN 123. In contrast, in a User Plane (UP) location solution, such as the Secure User Plane Location (SUPL) solution defined by the Open Mobile Alliance (OMA), signaling to support location of UE 105 may be transferred between participating entities (e.g. UE 105 and a location server such as E-SLP 168) using data bearers (e.g. using the Internet Protocol (IP) and/or Transmission Control Protocol (TCP)). E-SLP 168 may support location of UE 105 in a similar manner to E-SMLC 174, but may employ the SUPL user plane location solution instead of a CP location solution as used by E-SMLC 174.

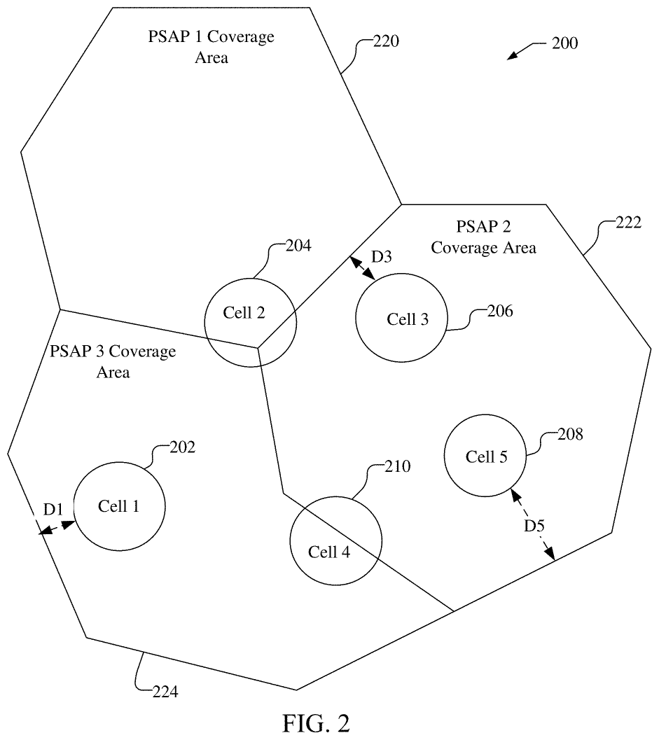

It should be understood that while FIG. 1 (and FIGS. 2-4 following) illustrates an LTE network architecture, other network architectures may be used if desired, such as a Next Generation (NG) Radio Access Network (RAN) (referred to as an NG-RAN), comprising one or more New Radio (NR) Node Bs (referred to as gNBs) or next generation eNBs (ng-eNBs) in place of eNB 110. In some other embodiments, both the E-UTRAN 123 and EPC 101 may be replaced by other RANs and other core networks. For example, in an Fifth Generation (5G) core network (SGCN) defined by 3GPP to support NR and LTE access: the E-UTRAN 123 may be replaced by an NG-RAN containing gNBs and/or ng-eNBs in place of eNB 110; and the EPC 101 may be replaced by a SGCN comprising an Access and Mobility Management Function (AMF) and Session Management Function (SMF) in place of MME 172, a Location Management Function (LMF) in place of the E-SMLC 174, and a User Plane Function (UPF) in place of both the Serving Gateway 115 and PDN Gateway 122. In a SGCN, the GMLC 170, IMS 182 and LRF 192 may be included with no change or only small change. In such a SGCN, the LMF may use New Radio Position Protocol A (which may be referred to as NRPPa) in place of an LTE Positioning Protocol A (LPPa) used by the E-SMLC 174 to send and receive location information to and from gNBs and/or ng-eNBs in the NG-RAN and may use LPP to support positioning of UE 105. In addition, in some implementations, base stations (e.g. similar to or based on an eNB 110, gNB or an ng-eNB) may function as positioning only beacons and transmit signals (e.g. PRS) to assist positioning of a UE 105 but not receive signals.

Location-Based Routing may only be needed for a subset of cells for any wireless network. Cells well inside a PSAP coverage area may be flagged in a cell database for a wireless network as permitting cell based routing, which may restrict the additional delay for LBR to cells on or near the periphery of a PSAP coverage area.

LPP, as defined in 3GPP TS 36.355 and TS 37.355, supports an early location fix capability, whereby a location server (e.g. E-SMLC 174) can request an early location fix followed by a final more accurate location fix. The location server can indicate this request to a UE 105 by sending an LPP message to UE 105 (e.g. an LPP Request Location Information message) and including two response times in the LPP message: a “responseTimeEarlyFix” for the early location and a final response time for the final location (e.g. with both response times lying between 1 and 128 seconds). The early and final location fix can each be a location estimate or a set of measurements (e.g. measurements for A-GPS, A-GNSS, ECID, OTDOA or WLAN). A benefit of this procedure compared to using two separate LPP requests (one specifying a low response time and another specifying a higher response time) can be that the UE 105 will not discard the measurements used for the early location fix but will instead apply them to the final location fix which can improve the accuracy and/or or reduce the response time for the final location fix.

FIG. 2 illustrates, by way of example, a geographic region 200 that includes a number of network cells 202, 204, 206, 208, and 210 and coverage areas 220, 222, and 224 of a PSAP 1, PSAP 2, and PSAP 3, respectively. As can be seen, network cells 204 and 210 overlap the coverage areas of two or more PSAPs, e.g., cell 204 overlaps the coverage areas 220, 222, and 224, while cell 210 overlaps coverage areas 222 and 224. Thus, an emergency call originating from cell 204 may need to be routed to one of PSAP 1, PSAP 2, or PSAP 3, and an emergency call originating from cell 210 may need to be routed to one of PSAP 2 or PSAP 3, depending on exactly where in either cell, a UE 105 is located. Accordingly, the serving cell ID by itself cannot be used reliably to determine which PSAP is the appropriate PSAP to receive an emergency call originating from the network cells 204 or 210. Thus, LBR may be needed to correctly route an emergency call originating in either of the network cells 204 and 210 to the appropriate PSAP.

The use of LBR for routing emergency calls, however, may require additional time and resources to obtain the location of a UE 105, and, accordingly, it may be advantageous to avoid the use of LBR if possible. For example, if a cell is completely within the coverage area of a PSAP, it may be advantageous to use the serving cell ID to identify the appropriate PSAP for an emergency call. However, if a network cell has a coverage area close to the boundary of a PSAP coverage area, it may be possible (occasionally) for a UE 105 to access the base station for the network cell when outside the network cell coverage area and located in the coverage area for a different PSAP. Accordingly, even if a network cell is completely within the coverage area of a PSAP, it may be advantageous to determine whether to use LBR for routing an emergency call based on the network cell's proximity to the boundary of the coverage area of a PSAP. For example, in some implementations, the distance of the coverage area of a network cell from the boundary (or periphery) of the coverage area of a PSAP may be compared to a threshold distance to determine if the serving cell ID may be used for routing an emergency call or if LBR should be used for routing the emergency call.

For example, as can be seen in FIG. 2, network cells 202, 206, and 208 do not overlap PSAP coverage areas and are completely within the interior regions of PSAP coverage areas. Cell 202 is at a distance D1 from the periphery of the coverage area 224 of PSAP 3, while cells 206 and 208 are at distances D3 and D5, respectively, from the periphery of the coverage area 222 of PSAP 2. The distances D1 and D3, for example, may be less than a predetermined threshold distance and, accordingly, it may not be appropriate to rely on the serving cell IDs for cells 202 and 206 to identify an appropriate PSAP to route emergency calls. Accordingly, LBR may be used for cells 202 and 206 to route an emergency call to the appropriate PSAP. On the other hand, distance D5 may be greater than the predetermined threshold distance, indicating that any emergency call originating from a UE 105, whose serving cell is cell 208, can always be routed correctly to PSAP 2. Accordingly, the cell ID for cell 208 may be used to route all emergency calls from any UE 105, whose serving cell is cell 208, to the appropriate PSAP, i.e., PSAP 2. Thus, in a cell database for a wireless network which includes cells 202-210, there may be an indication for cell 208 indicating that LBR is not needed for an emergency call from a UE 105 with cell 208 as the current serving cell, whereas there may be indications for cells 202, 204, 206 and 210 indicating that LBR is needed for an emergency call from a UE 105 with any of these cells as the current serving cell.

Thus, in one implementation, a cell database stored in, e.g., MME 172, E-SMLC 174 and/or LRF 192, may flag network cell 208 as permitting cell based routing, while cells 202, 204, 206, and 210 may be flagged as requiring LBR routing.

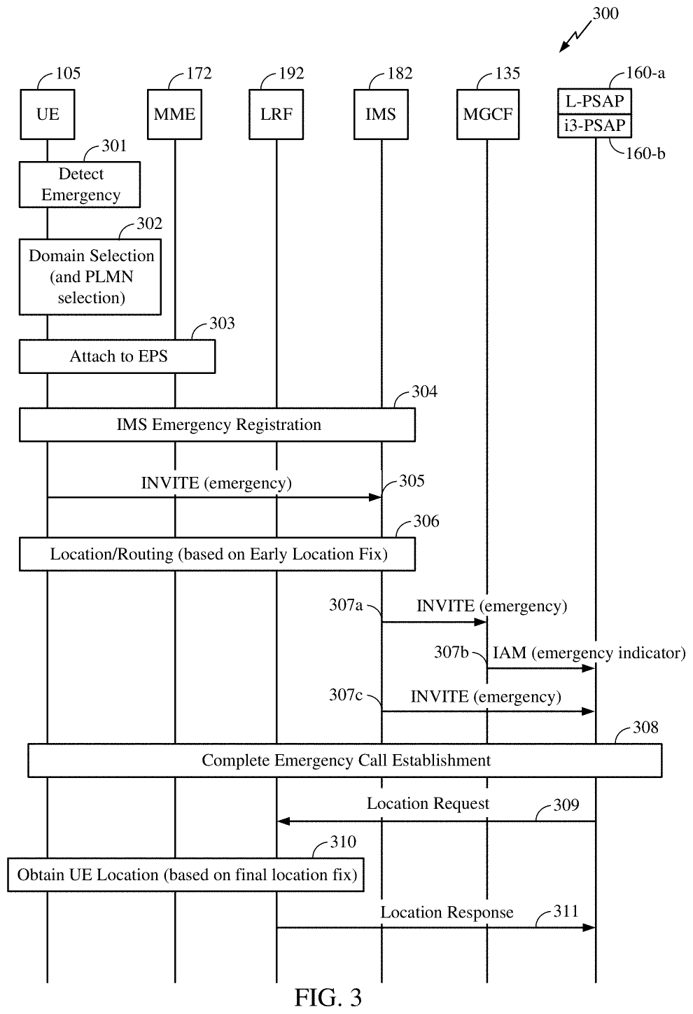

FIG. 3 shows an example message flow 300 illustrating how various components of wireless communications system 100, as discussed with reference to FIG. 1, can establish an IMS emergency call in accordance with aspects of the current disclosure. Here, some principal elements, but not all elements, of the EPC 101 are shown. Some actions attributed to or implied for certain elements or certain groups of elements of the EPC 101 shown in FIG. 3 may be supported in part by other elements of EPC 101 not shown in FIG. 3. For example, references to actions performed by or involving MME 172 can be assisted or provided by the eNB 110, Serving Gateway 115, PDN Gateway 122, and/or other components of EPC 101 shown in FIG. 1, and the IMS 182 in FIG. 3 can refer to the P-CSCF 126 and/or the E-CSCF 132 of FIG. 1, or may correspond to all the elements of the IMS 182 of FIG. 1. As mentioned previously, techniques disclosed herein are not necessarily limited to the architecture illustrated in FIG. 1.

At stage 301 in FIG. 3, the UE 105 detects an emergency situation either via manual user input or possibly automatically using sensors.

At stage 302, the UE 105 performs domain selection to select either the Circuit Switched (CS) or Packet Switched (PS) domain and find an accessible wireless network supporting this domain. If the CS domain is selected (not shown in FIG. 3), a CS emergency call is instigated (not shown). If the PS domain is selected, as shown in FIG. 3, E-UTRAN 123 and EPC 101 are accessed and the rest of the operations in FIG. 3 are performed.

At stage 303, UE 105 attaches to EPC 101 and E-UTRAN 123 if not already attached. The attachment at stage 303 is supported by MME 172 and by other elements not shown in FIG. 3, such as eNB 110 and PDN gateway 122. During the attachment at stage 303, UE 105 obtains an emergency PDN Connection and an emergency bearer and discovers a P-CSCF 126 suitable for emergency services. The UE 105 may release resources (e.g., bearer resources) for any previous ongoing sessions if needed to perform this stage.

At stage 304, the UE 105 performs an IMS emergency registration with the IMS 182. The IMS emergency registration at stage 304 may also be performed with the IMS 182 in a home network for the UE 105 (not shown in FIG. 3) if the UE 105 is roaming (e.g., if EPC 101 is not part of home network for UE 105).

At stage 305, the UE 105 sends a SIP INVITE message to the IMS 182 (e.g., to the P-CSCF 126). The INVITE sent at stage 305 indicates an emergency call.

At stage 306, the IMS 182 (e.g., the E-CSCF 132) may query the LRF 192 to obtain call routing and/or location information for the UE 105 and the LRF 192 may obtain the location of the UE 105 (e.g., via an interaction involving the UE 105, GMLC 170, MME 172, and E-SMLC 174 when a CP location solution is used or via an interaction involving UE 105 and E-SLP 168 when a UP location solution is used) in order to provide call routing and/or location information. For example, as discussed both above and further below, whether the emergency call requires LBR may be determined based on a serving cell (e.g. a serving cell identity) for the UE, where a location estimate based on early location information from the UE 105 may be obtained if the emergency call requires LBR. The location estimate obtained for LBR may then be used to determine routing information for the emergency call which may enable routing of the emergency call either to or at least towards a PSAP 160. If the serving cell identity for UE 105 does not indicate LBR, the serving cell identity, or a location estimate obtained based on the serving cell identity, may be used to determine routing information for the emergency call which may enable routing of the emergency call either to or towards a PSAP 160.

At stages 307a-c, the IMS 182 (e.g., the E-CSCF 132) uses any routing information obtained in stage 306 (e.g., provided by LRF 192) or selects an emergency center or PSAP 160 based on information provided in stage 305 and sends the IMS emergency call request (e.g., SIP INVITE message) including any location information obtained in stage 305 or stage 306 to or towards the emergency center or PSAP 160. If the emergency center or PSAP 160 is accessed over the Circuit Switched (CS) domain (e.g., the PSAP 160 is a legacy PSAP 160-a), stages 307a and 307b are performed. For stage 307a, the SIP INVITE is sent to MGCF 135. For stage 307b, the MGCF 135 sends an ISUP Initial Address Message (IAM) towards the legacy PSAP 160-a (e.g., sends the IAM to the legacy ES network 145). The IAM may carry an emergency indication (e.g., in a Calling Party's Category parameter).

If the emergency center or PSAP 160 is accessed over the Packet Switched (PS) domain (e.g., the PSAP is i3 PSAP 160-b), stage 307c is performed. For stage 307c, the IMS 182 (e.g., the E-CSCF 132) sends the SIP INVITE to or towards the i3 PSAP 160-b (e.g., via IBCF 144 and the i3 ESInet 155) carrying the emergency indication.

At stage 308, the emergency call establishment is completed. This includes establishing a voice path (also referred to as a voice channel or audio channel) between the UE 105 and the PSAP (either legacy PSAP 160-a or i3 PSAP 160-b). In the case of an IMS emergency call to i3 PSAP 160-b, the voice path may employ VoIP and not need any conversion between different voice encodings. In the case of an IMS emergency call to legacy PSAP 160-a, the voice path may go through MGW 142 associated with the MGCF 135 and may also go through other entities as described for FIG. 1 and may undergo one or more transformations, such as conversion between VoIP encoding and CS voice encoding at MGW 142.

At stage 309, the PSAP (either legacy PSAP 160-a or i3 PSAP 160-b) sends a location request for the UE 105 to the LRF 192 and includes some identification for UE 105 or for the emergency call that may have been received at stage 307b or stage 307c and that is also known to LRF 192.

At stage 310, the location of the UE 105 is obtained (e.g. using a CP or UP location solution as described earlier). The location estimate obtained at stage 310 may be obtained within a response time that exceeds the response time for obtaining the location information at stage 306 when LBR is used. For example, as discussed further below, the location of the UE 105 may be obtained at stage 310 based on final location information provided by the UE 105, e.g., where a location estimate based on early location information from the UE 105 was provided in stage 306. If it was determined that the emergency call does not require LBR in stage 306, and routing in stage 306 was based on the serving cell identity, then the location obtained at stage 310 may be the only estimated location for the UE 105.

At stage 311, the LRF 192 returns the UE location to the PSAP (either legacy PSAP 160-a or i3 PSAP 160-b).

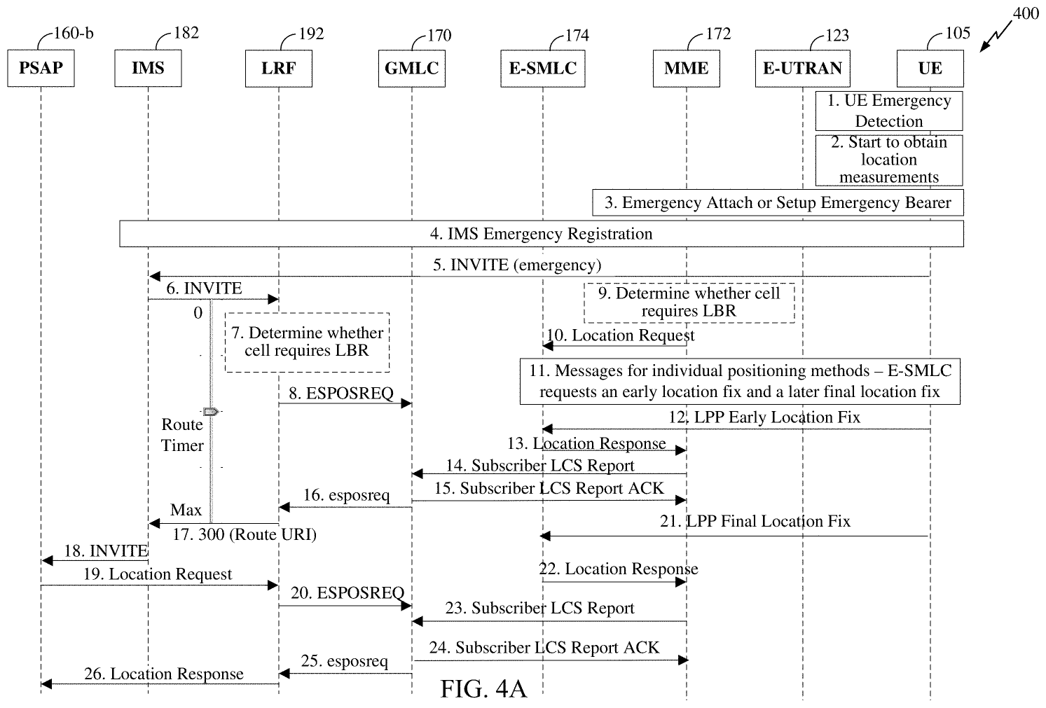

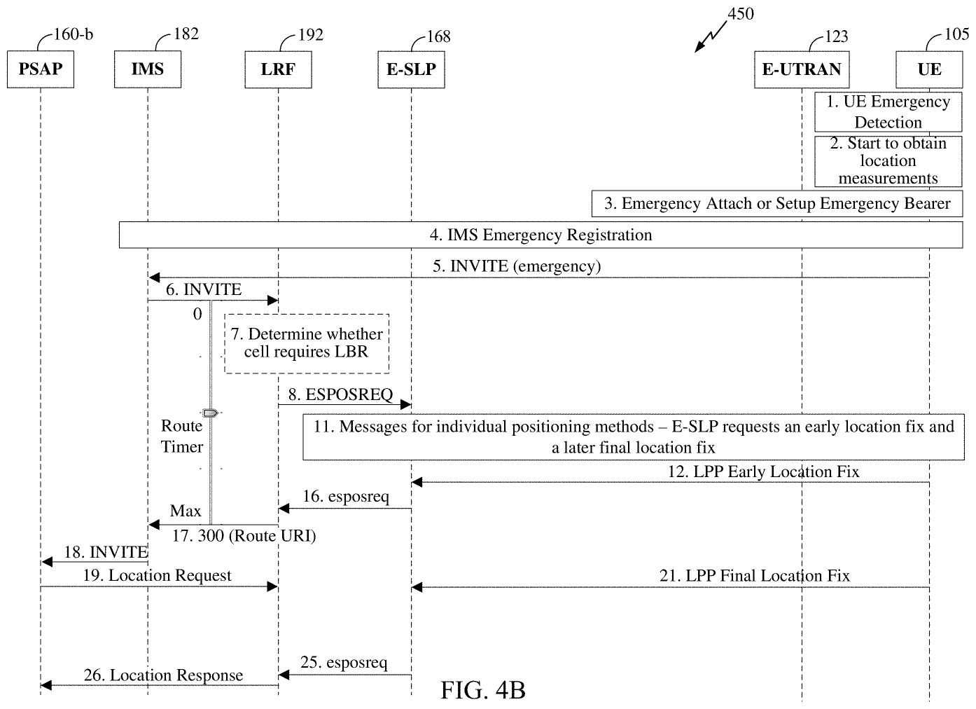

FIG. 4A shows an example message flow 400 illustrating an IMS emergency call in accordance with aspects of the current disclosure, where a CP location solution is used to obtain a location estimate for UE 105. The message flow shown in FIG. 4A advantageously does not require any architectural changes and only small changes to existing signaling procedures for an EPC (e.g. EPC 101) or a SGCN. The message flow in FIG. 4A is described here in two parts to avoid confusion. In a first part (referred to here as “part one”), it is assumed that LBR is used, and in a second part (referred to here as “part two”), it is assumed that LBR is not used. Description for part one follows directly below.

At stage 1 in FIG. 4A, the UE 105 detects an emergency call. The UE 105 may detect the emergency situation either via manual user input or possibly automatically using sensors.

At stage 2, the UE 105 may start to obtain location measurements in anticipation of the location request at stage 11.

At stage 3, the UE 105 performs domain selection to select either the CS or PS domain and finds an accessible wireless network supporting this domain. If the CS domain is selected (not shown in FIG. 4A), a CS emergency call is instigated (not shown). If the PS domain is selected, as shown in FIG. 4A, E-UTRAN 123 and EPC 101 are accessed and the rest of the operations in FIG. 4A are performed. UE 105 then attaches to EPC 101 and E-UTRAN 123 if not already attached. During the attachment at stage 3, UE 105 obtains an emergency PDN connection and an emergency bearer and discovers a P-CSCF 126 suitable for emergency services. MME 172 becomes aware of the emergency call from the emergency attach or setup of an emergency PDN connection at stage 3.

At stage 4, the UE 105 performs an IMS emergency registration with the IMS 182. The IMS emergency registration at stage 4 may also be performed with the IMS 182 in a home network for the UE 105 (not shown in FIG. 4A) if the UE 105 is roaming (e.g., if EPC 101 is not part of home network for UE 105).

At stage 5, the UE 105 sends a SIP INVITE message to the IMS 182 (e.g., to the P-CSCF 126). The INVITE sent at stage 5 indicates an emergency call and includes the serving cell identity for UE 105.

At stage 6, the IMS 182 (e.g., the E-CSCF 132) forwards the INVITE to the LRF 192.

At stage 7, the LRF 192 optionally may determine whether the serving cell for the UE 105 (which is indicated in the INVITE) requires LBR. For example, the LRF 192 may determine if the serving cell requires LBR using a database that lists network cells and whether LBR is or is not needed for each cell.

At stage 8, if the LRF 192 determines that the serving cell for the UE 105 requires LBR in stage 7 (as assumed here for part one), or if stage 7 is not performed, the LRF 192 sends the GMLC 170 an Emergency Services Position Request (ESPOSREQ) message to request the location of the UE 105.

At stage 9, the MME 172 optionally may determine whether the serving cell for the UE 105 requires LBR. Thus, one, both or neither of the MME 172 and the LRF 192 (at optional stage 7) may determine whether the serving cell requires LBR. As in stage 7, the MME 172 may determine if the serving cell requires LBR using a database that lists network cells and whether or not LBR is needed for each cell.

At stage 10, the MME 172 sends a location request for the UE 105 to the E-SMLC 174 and includes the identity of a current serving cell for UE 105 (e.g. as indicated to MME 172 as part of stage 3). If, at stage 9, the MME 172 determines that the serving cell for the UE 105 requires LBR, or if stage 9 is not performed, the location request may include an indication that LBR is required. For example, the location request may include a combined request for an early location estimate and a final location estimate from the E-SMLC 174.

At stage 11, the E-SMLC 174 optionally may first determine whether LBR is needed. This may be based on a determination by the MME 172 at stage 9, which may be forwarded to the E-SMLC 174 at stage 10. Alternatively, E-SMLC 174 may determine whether LBR is needed based on the serving cell ID received at stage 10 and using a cell database that lists network cells and whether or not LBR is needed for each cell. If LBR is needed, as optionally determined by the E-SMLC 174, or if LBR is always used (e.g., if E-SMLC 174 does not make a determination of whether LBR is needed), then the E-SMLC 174 requests an early location fix and a final location fix from the UE 105 at stage 11 by sending a single combined LPP request to the UE 105 (e.g. an LPP Request Location Information message). For example, the response time for the early location fix can be set to a few seconds, e.g., using an LPP ResponseTime responseTimeEarlyFix parameter, while the response time for the final location fix can be set to 20-30 seconds, e.g., using an LPP ResponseTime time parameter. In some embodiments, E-SMLC 174 may first request and obtain the positioning capabilities of UE 105 from UE 105 using LPP and may verify that UE 105 supports an LPP early location fix before sending the combined location request to UE 105 at stage 11 for an early and final location fix.

At stage 12, and assuming an early and a final fix were both requested at stage 11 to support LBR, the UE 105 returns an LPP Early Location Fix message (e.g. an LPP Provide Location Information (PLI) message) including early location fix information, which may be location measurements performed by the UE 105 or a location estimate determined by the UE 105, or both.

At stage 13, the E-SMLC 174 determines or verifies a first location estimate for the UE 105 based on the early location fix information and returns the first location estimate to the MME 172 in a normal location response, and may include an indication of an early location estimate. The first location estimate is typically more accurate than a location obtained based on the serving cell identity alone, since it can be based on location measurements obtained by UE 105. For example, the first location estimate may be obtained using ECID, OTDOA, A-GNSS, multi-cell RTT, WLAN or some combination of these.

At stage 14, the MME 172 determines a GMLC 170 (e.g. based on the serving cell ID or as configured in MME 172 for all emergency calls) and sends the first location estimate to the GMLC 170 in an LCS report and includes an indication that this is an early location estimate.

At stage 15, the GMLC 170 may send an acknowledgment message to the MME 172 when stage 14 is performed.

At stage 16, if stage 8 was performed, the GMLC 170 provides the first location estimate to the LRF 192 in an Emergency Services Position Request Response (esposreq) message, following the request at stage 8.

At stage 17, if the LRF 192 determined that the serving cell for the UE 105 requires LBR in stage 7, or if stage 7 was not performed, the LRF 192 may determine routing information (e.g. which may be an address of a PSAP 160 or the address of an intermediate entity) for the emergency call based on the first location estimate received at stage 16, where the routing information enables routing of the emergency call to or towards the PSAP 160. For example, the LRF 192 may return the routing information and optionally the first location estimate to the IMS 182 in a SIP 300 (Route URI) message.

At stage 18, the IMS 182 may send an INVITE message to or towards the appropriate PSAP 160 based on the routing information received at stage 17. An emergency call may then be established between the UE 105 and PSAP 160 via the IMS 182.

At stage 19, the PSAP 160 sends a location request for the UE 105 to the LRF 192.

At stage 20, the LRF 192 sends the GMLC 170 an ESPOSREQ message to request the location of the UE 105.

At stage 21, the UE 105 returns an LPP Final Location Fix (referred to as a second location estimate) to the E-SMLC 174 (e.g. in an LPP PLI message), which may include late fix location information, which may be location measurements performed by the UE 105 or a location estimate determined by the UE 105, or both.

At stage 22, the E-SMLC 174 determines or verifies a second location estimate for the UE 105 and returns the second location estimate to the MME 172 (e.g. using the same type of message as sent at stage 13), and may include an indication of a final location estimate. The second location estimate may be more accurate than the first location estimate (when this is provided) and may be suitable for PSAP dispatch of a public safety responder. For example, the second location estimate may be obtained using ECID, OTDOA, multi-cell RTT, A-GNSS, WLAN or some combination of these.

At stage 23, the MME 172 provides the second location estimate to the GMLC 170 in an LCS Report (e.g. using the same type of message as sent at stage 14 when stage 14 occurs) and includes an indication that this is a final location estimate (if stage 14 has occurred).

At stage 24, the GMLC 170 may send an acknowledgment message to the MME 172.

At stage 25, the GMLC 170 provides the second location estimate to the LRF 192 in an esposreq message, following the location request at stage 20.

At stage 26, the LRF 192 provides a location response to the PSAP 160 that includes the second location estimate obtained at stage 25.

Where LBR is used and where an early location fix and a final location fix are obtained as described above, the signaling for stages 22-24 may be the same as for stages 13-15 with the difference that stages 13 and 14 indicate an early location fix, whereas stages 22 and 23 indicate a final location fix. The location request/response transaction between the MME 172 and E-SMLC 174 then starts at stage 10 and terminates after the response for the final location fix at stage 22.

When LBR is not used, some stages of FIG. 4A are different to those described above for part one and are as follows for part two.

Stages 1-6 are first performed as described above for part one.

Stage 7 may then be optionally performed, as described above for part one, to determine whether LBR is needed based on the serving cell for UE 105. If the LRF 192 determines that the serving cell for the UE 105 does not require LBR (as assumed here for part two), the message flow may proceed to stage 17, with stages 8 and 12-16 optionally not being performed.

Stage 8 may optionally be performed as described above for part one—e.g. may be performed if stage 7 is not performed.

At stage 9, MME 172 may optionally determine whether the serving cell for the UE 105 requires LBR, as described above for part one.

Stage 10 may be performed as described above for part one. If the MME 172 determines that the serving cell for the UE 105 does not require LBR at stage 9, MME 172 may provide an indication at stage 10 that LBR is not required. For example, the location request sent at stage 10 may include a request for one location estimate from the E-SMLC 174 or may simply not include a request for an early and a separate final location estimate.

At stage 11, the E-SMLC 174 may optionally first determine whether LBR is needed as described above for part one. If LBR is not needed, e.g., as optionally determined by the E-SMLC 174 at stage 11 or by the MME 172 at stage 9, the E-SMLC 174 may request one location estimate from the UE 105 at stage 11, where the one location estimate from the UE 105 arrives at stage 21. Stage 12 shown in FIG. 4A accordingly does not typically occur for part two.

At stage 13, if LBR is not required and stage 12 is not performed, the E-SMLC 174 may send the first location response at stage 13 immediately after determining that LBR is not required with either (a) an indication that LBR is not needed and without a location estimate (referred to here as “case (a)”), or (b) with a first location estimate based on the serving cell (referred to here as “case (b)”). Alternatively (e.g. if stage 7 will be performed by LRF 192), stages 13-15 (as well as stages 8, 12 and 16) may not be performed.

If LBR is not required, the MME 172 may not perform stage 14 (e.g. as described above) or may perform stage 14 and may include an indication that LBR is not needed for case (a) above or may include the first location estimate based on the serving cell for case (b) above.

Stages 15 and 16 may not occur as described above, or may occur as described for part one, except that for stage 16, GMLC 170 may provide an indication that LBR is not needed if stage 14 occurs with an indication that LBR is not needed.

At stage 17, if the LRF 192 determined that the serving cell for the UE 105 does not require LBR at stage 7, or if stage 16 occurs and indicates that LBR is not needed, the LRF 192 may provide routing information at stage 17 based on the serving cell identity for the UE 105 in the 300 (Route URI) message. For example, LRF 192 may return the address of a PSAP 160 or the address of an entity on a route towards a PSAP 160 which is based on the serving cell identity for UE 105.

Stages 18-20 may then occur as described for part one.

At stage 21, if LBR is not needed (e.g. as determined by MME 172 at stage 9 or by E-SMLC 174 at stage 11) and stage 11 was performed to request one location estimate only, then UE 105 returns a location fix at stage 21 (but not at stage 12) as both a single and final location fix.

At stage 22, if LBR is not needed (e.g. as determined by MME 172 at stage 9 or by E-SMLC 174 at stage 11), stage 22 occurs to provide the single location estimate received at stage 21 to the MME 172.

Stages 23-26 then occur as described for part one with the single location estimate obtained at stage 22 replacing the second location estimate described above for part one.

FIG. 4B shows an example message flow 450 illustrating an IMS emergency call in accordance with aspects of the current disclosure, where a UP location solution is used to obtain a location estimate for UE 105. The message flow shown in FIG. 4B is similar to that described for FIG. 4A, where stages that are shown for FIG. 4B correspond to like numbered stages for FIG. 4A, and are as described above for FIG. 4A except where stated otherwise below. Stages shown in FIG. 4A for which like numbered stages are not included in FIG. 4B are omitted from FIG. 4B. The correspondence between FIGS. 4A and 4B also includes aspects described above for parts one and two of FIG. 4A which apply also to FIG. 4B according to whether LBR is used (for part one) or is not used (for part two). Part one of FIG. 4B proceeds as follows.

Stages 1-7 in FIG. 4B are performed as described above for stages 1-7 for part one of FIG. 4A. If, at stage 7, the LRF 192 determines that the serving cell for the UE 105 requires LBR, or if stage 7 is not performed, the LRF 192 sends an ESPOSREQ request, or a similar request message for the Mobile Location Protocol (MLP) defined by OMA, to E-SLP 168 at stage 8 to request a location estimate for the UE 105. The request at stage 8 may include an indication that LBR is required (e.g. may include a combined request for an early location estimate and a final location estimate from E-SLP 168).

Stage 11 in FIG. 4B is performed in response to stage 8 and is as described above for stage 11 of part one of FIG. 4A, with E-SLP performing the actions described for E-SMLC 174, except that the E-SLP 168 may base a determination of whether LBR is needed on information received from LRF 192 at stage 8 (rather than on information received from MME 172 in the case of FIG. 4A). In addition, E-SLP 168 establishes a SUPL session with UE 105 prior to exchanging LPP messages with UE 105 at stage 11, and each LPP message that is exchanged for stage 11, stage 12 and stage 21 is transported within a SUPL message (e.g. a SUPL POS message) which is sent between E-SLP 169 and UE 105 at a user plane level (e.g. may be sent through eNB 110, Serving Gateway 115 and PDN Gateway 122 using TCP/IP or UDP/IP).

Stage 12 is as described above for stage 12 for part one of FIG. 4A with E-SLP 169 replacing E-SMLC 174. In response to stage 12, and at stage 16, E-SLP 168 provides the first location estimate to the LRF 192 in an esposreq message, or in a similar message for MLP.

Stages 17-19 are performed as described above for stages 17-19 for part one of FIG. 4A.

At stage 21 (and in response to stage 11), the UE 105 returns an LPP Final Location Fix (referred to as a second location estimate) to the E-SLP 168 (e.g. in an LPP PLI message), which may include late fix location information, which may be location measurements performed by the UE 105 or a location estimate determined by the UE 105, or both.

At stage 25, and in response to stage 21, the E-SLP 168 determines or verifies a second location estimate for the UE 105 and returns the second location estimate to the LRF 192 (e.g. using the same type of message as sent at stage 16 which may be an esposreq or a similar message for MLP). The second location estimate may be more accurate than the first location estimate (when this is provided) and may be suitable for PSAP dispatch of a public safety responder. For example, the second location estimate may be obtained using ECID, OTDOA, multi-cell RTT, A-GNSS, WLAN or some combination of these.

Stage 26 may be as described above for stage 26 for part one of FIG. 4A.

Part two of FIG. 4B is as described above for part one of FIG. 4B with the following differences.

At stage 7, LRF 192 determines that LBR is not needed. Stage 8 may then be performed to request a single location estimate either in response to stage 7 or later in response to stage 19. Stage 11 is performed by E-SLP 168 in response to stage 8 but E-SLP sends an LPP request to UE 105 to request only a single location estimate. Stages 12 and 16 are not performed. Stage 17 is performed by LRF 192 in response to stage 7 to provide routing information to IMS 182 based on the serving cell for UE 105 (e.g. the serving cell identity). Stages 18-26 are performed as described above for part one of FIG. 4B except that the location estimate returned at stages 21, 25 and 26 is a single location estimate and not a second location estimate.

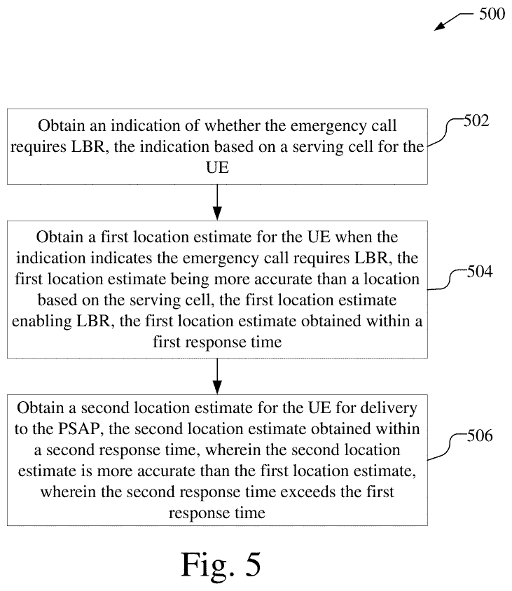

FIG. 5 shows a process flow 500 illustrating a method performed by a first network entity in a wireless network for supporting location based routing (LBR) of an emergency call for a user equipment (e.g. the UE 105) to a Public Safety Answering Point (e.g. a PSAP 160). The first network entity, for example, may be any of a location server, such as E-SMLC 174, an LMF or E-SLP 168; a mobility management function, such as MME 172 or an AMF; or a location retrieval function, such as LRF 192.

Process flow 500 may start at block 502, where an indication of whether the emergency call requires LBR is obtained, where the indication is based on a serving cell (e.g. a serving cell identity) for the UE, e.g., as described at stage 306 in FIG. 3, stages 7 and 9, 10 and 11 in FIG. 4A, and stages 7 and 11 in FIG. 4B.

At block 504, a first location estimate for the UE is obtained when the indication indicates the emergency call requires LBR, where the first location estimate is more accurate than a location based on the serving cell (e.g. the serving cell identity), where the first location estimate enables LBR, and where the first location estimate is obtained within a first response time, e.g., as described at stage 306 in FIG. 3, stages 12, 13, 14 and 16 of FIG. 4A and stages 12 and 16 of FIG. 4B.

At block 506, a second location estimate for the UE is obtained for delivery to the PSAP, where the second location estimate is obtained within a second response time, where the second location estimate is more accurate than the first location estimate, and where the second response time exceeds the first response time, e.g., as described at stage 310 of FIG. 3, stages 21, 22, 23 and 25 of FIG. 4A, and stages 21 and 25 of FIG. 4B.

In one implementation, the indication indicates the emergency call requires LBR when a coverage area for the serving cell overlaps the coverage areas of at least two PSAPs, e.g., as described at FIG. 2.

In one implementation, the indication indicates the emergency call requires LBR when a coverage area for the serving cell is within a threshold distance of a periphery of a coverage area of a PSAP, e.g., as described at FIG. 2.

In one implementation, the emergency call is routed to the PSAP based on the serving cell (e.g. the serving cell identity), when the indication indicates the emergency call does not require LBR, e.g., as described at FIG. 2, stage 306 in FIG. 3, stages 7, 9 and 10 for part two of FIG. 4A, and stage 7 for part two of FIG. 4B.

In one implementation, the first location estimate is based on early location information provided by the UE using Long Term Evolution Positioning Protocol (LPP), wherein the second location estimate is based on final location information provided by the UE using LPP, wherein the first response time comprises an LPP ResponseTime responseTimeEarlyFix parameter and the second response time comprises an LPP ResponseTime time parameter, e.g., as described for stages 11, 12, and 21 of FIG. 4A. For example, in one implementation, the process may obtain the indication of whether the emergency call requires LBR based on a cell database, e.g., as described at stages 7, 9 and 11 of FIG. 4A and stages 7 and 11 of FIG. 4B.

In one implementation, the process may further include sending a combined request for the first location estimate and the second location estimate to a location server, e.g., as described for stage 10 for part one of FIG. 4A. A first response may be received from the location server, where the first response comprises the first location estimate, e.g., as described for stage 13 for part one of FIG. 4A. The first location estimate may be sent to a second network entity in a first message, e.g., as described at stage 14 for part one of FIG. 4A. A second response may be received from the location server, where the second response comprises the second location estimate, and where the second response comprises the same message type as the first response, e.g., as described for stage 22 of part one of FIG. 4A. The second location estimate may be sent to the second network entity in a second message, where the second message comprises the same message type as the first message, e.g., as described for stage 23 for part one of FIG. 4A. In a further implementation, the process may further comprise including the indication of whether the emergency call requires LBR in the combined request when the indication indicates the emergency call requires LBR, e.g., as discussed at stage 10 for part one of FIG. 4A. In a further implementation, the first response includes an indication of an early location estimate, the second response includes an indication of a final location estimate, the first message includes an indication of an early location estimate, and the second message includes an indication of a final location estimate, e.g., as described at stages 13, 14 and 22, 23 for part one of FIG. 4A. In one implementation, the first network entity is a Mobility Management Entity (e.g., MME 172) or an Access and Mobility Management Function (AMF), the location server is an Evolved Serving Mobile Location Center (e.g. E-SMLC 174) or a Location Management Function (e.g. LMF), and the second network entity is a Gateway Mobile Location Center (e.g. GMLC 170).

In one implementation, the first network entity is a location server, and the process may further include receiving a first combined request for the first location estimate and the second location estimate from a second network entity, e.g., as discussed at stage 10 for part one of FIG. 4A and stage 8 for part one of FIG. 4B. A second combined request may be sent for the first location estimate and the second location estimate to the UE using a Long Term Evolution Positioning Protocol (LPP), e.g., as discussed at stage 11 for part one of FIG. 4A and stage 11 for part one of FIG. 4B. A first LPP response from the UE may be received, where the first LPP response comprises the first location estimate, e.g., as discussed for stage 12 for part one of FIG. 4A and stage 12 for part one of FIG. 4B. The first location estimate may be sent to the second network entity in a first response message, e.g., as discussed at stage 13 for part one of FIG. 4A and stage 16 for part one of FIG. 4B. A second LPP response may be received from the UE, where the second LPP response comprises the second location estimate, and where the second LPP response may comprise the same LPP message type as the first LPP response, e.g., as discussed at stage 21 for part one of FIG. 4A and stage 21 for part one of FIG. 4B. The second location estimate may be sent to the second network entity in a second response message, where the second response message may comprise the same message type as the first response message, e.g., as discussed at stage 22 for part one of FIG. 4A and stage 25 for part one of FIG. 4B. In one implementation, the second network entity is a Mobility Management Entity (e.g. MME 172), an Access and Mobility Management Function (AMF) or a Location Retrieval Function (e.g. LRF 192), and the location server is an Evolved Serving Mobile Location Center (e.g. E-SMLC 174), a Location Management Function (LMF) or Secure User Plane Location (SUPL) Location Platform (e.g. E-SLP 168).

In one implementation, obtaining the first location estimate comprises receiving the first location estimate from a second network entity, and obtaining the second location estimate comprises receiving the second location estimate from the second network entity, e.g., as discussed at stages 16 and 25 for part one of FIG. 4A and stages 16 and 25 for part one of FIG. 4B. In a further implementation, the process may further include determining routing information for the emergency call based on the first location estimate, where the routing information enables routing of the emergency call to or towards the PSAP, e.g., as discussed at stage 17 for part one of FIG. 4A and stage 17 for part one of FIG. 4B. In a further implementation, the process may further include: (i) receiving a location request for the UE from the PSAP, e.g., as discussed at stage 19 for part one of FIGS. 4A and 4B; and (ii) sending a response to the PSAP, where the response comprises the second location estimate, e.g., as discussed at stage 26 for part one of FIGS. 4A and 4B. In one implementation, the first network entity is a Location Retrieval Function (e.g. LRF 192) and the second network entity is a gateway mobile location center (e.g. GMLC 170) or a Secure User Plane Location (SUPL) Location Platform (e.g. E-SLP 168).

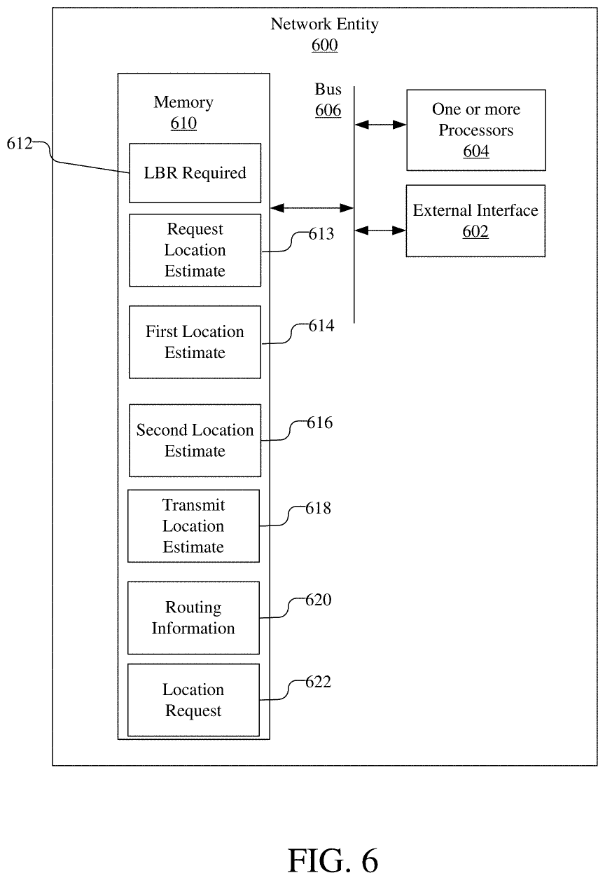

FIG. 6 is a diagram illustrating an example of a hardware implementation of a network entity 600 in a wireless network for supporting location based routing (LBR) of an emergency call for a user equipment (UE) to a Public Safety Answering Point (PSAP). The network entity 600 may be an entity within a core network (e.g. EPC 101) or IMS (e.g. IMS 182) including any of a location server, such as E-SMLC 174, an LMF or E-SLP 168; a mobility management function, such as MME 172 or an AMF; a location retrieval function, such as LRF 192, or a GMLC such as GMLC 170, as discussed herein, and shown in FIGS. 1-5.

The network entity 600 includes, e.g., hardware components such as an external interface 602, which may be a wired or wireless interface capable of connecting to other entities, such as E-SMLC 174, an LMF or E-SLP 168; an MME 172 or an AMF; the UE 105, a GMLC 170, an IMS 182, or a PSAP 160, as applicable. The network entity 600 includes one or more processors 604 and memory 610, which may be coupled together with bus 606. The memory 610 may store data and may contain executable code or software instructions that when executed by the one or more processors 604 cause the one or more processors 604 to operate as a special purpose computer programmed to perform the procedures and techniques disclosed herein (e.g. such as the process flow 500).

As illustrated in FIG. 6, the memory 610 includes one or more components or modules that when implemented by the one or more processors 604 implements the methodologies described herein. While the components or modules are illustrated as software in memory 610 that is executable by the one or more processors 604, it should be understood that the components or modules may be dedicated hardware and/or firmware either in the processors 604 or off processor. As illustrated, the memory 610 may include a LBR required unit 612 that enables the one or more processors 604 to obtain an indication of whether the emergency call requires LBR, the indication based on a serving cell for the UE. For example, the indication of whether the emergency call requires LBR may be obtained by determining whether the emergency call requires LBR, e.g., using a database, such as a cell database, stored in memory 610, or by receiving the indication from another entity via the external interface 602. The indication may indicate that the emergency call requires LBR, e.g., when a coverage area for the serving cell overlaps the coverage areas of at least two PSAPs or when a coverage area for a serving cell for the UE is within a threshold distance of a periphery of a coverage area of a PSAP.

The memory 610 may further include a request location estimate unit 613 that enables the one or more processors 604 to send or receive a combined request for first and second location estimates to or from another network entity, e.g., via the external interface 602. The request for location estimates may include the indication of whether the emergency call requires LBR.

The memory 610 may further include a first location estimate unit 614 that enables the one or more processors 604 to obtain a first location estimate for the UE when the indication indicates the emergency call requires LBR, the first location estimate being more accurate than a location based on the serving cell identity, the first location estimate enabling LBR, the first location estimate obtained within a first response time. For example, the first location estimate for the UE may be obtained by receiving the location estimate from another entity, e.g., via the external interface 602, or by determining the first location estimate using location information provided by the UE 105 received via the external interface 602. The first location estimate may be based on early location information provided by the UE using Long Term Evolution Positioning Protocol (LPP). Where the first location estimate is received from another entity, e.g., in response to a request, the response may include an indication of an early location estimate.

The memory 610 may further include a second location estimate unit 616 that enables the one or more processors 604 to obtain a second location estimate for the UE for delivery to the PSAP, the second location estimate obtained within a second response time, wherein the second location estimate is more accurate than the first location estimate, wherein the second response time exceeds the first response time. For example, the first location estimate for the UE may be obtained by receiving the location estimate from another entity, e.g., via the external interface 602, or by determining the first location estimate using location information provided by the UE 105 received via the external interface 602. The second location estimate may be based on final location information provided by the UE using LPP, wherein the first response time may be an LPP ResponseTime responseTimeEarlyFix parameter and the second response time may be an LPP ResponseTime time parameter. Where the second location estimate is received from another entity, e.g., in response to a request, the response may include an indication of a final location estimate.

The memory 610 may further include a transmit location estimate unit 618 that enables the one or more processors 604 to send location estimates to another network entity, e.g., via the external interface 602. Where the location estimates are transmitted to another entity, a first message with the first location estimate may include an indication of the early location estimate, and a second message with the second location estimate may include an indication of the final location estimate.

The memory 610 may further include a routing information unit 620 that enables the one or more processors 604 to determine routing information for the emergency call based on the first location estimate, the routing information enabling routing of the emergency call to or towards the PSAP.

The memory 610 may further include a location request unit 622 that enables the one or more processors 604 to receive a location request for the UE from a PSAP, e.g., via the external interface 602. The one or more processors 604 may be further enabled to send a response to the PSAP that includes the second location estimate, e.g., via the external interface 602.

The methodologies described herein may be implemented by various means depending upon the application. For example, these methodologies may be implemented in hardware, firmware, software, or any combination thereof. For a hardware implementation, the one or more processors may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For an implementation involving firmware and/or software, the methodologies may be implemented with modules (e.g., procedures, functions, and so on) that perform the separate functions described herein. Any machine-readable medium tangibly embodying instructions may be used in implementing the methodologies described herein. For example, software codes may be stored in a memory (e.g. memory 610) and executed by one or more processor units (e.g. processors 604), causing the processor units to operate as a special purpose computer programmed to perform the techniques and procedures disclosed herein. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a non-transitory computer-readable storage medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable storage medium, instructions and/or data may be provided as signals on transmission media included in a communication apparatus. For example, a communication apparatus may include a transceiver having signals indicative of instructions and data. The instructions and data are stored on non-transitory computer readable media, e.g., memory 610, and are configured to cause the one or more processors (e.g. processors 604) to operate as a special purpose computer programmed to perform the techniques and procedures disclosed herein. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

In one implementation, a network entity, such as network entity 600, is configured to support location based routing (LBR) of an emergency call for a user equipment (UE) to a Public Safety Answering Point (PSAP), and includes a means for obtaining an indication of whether the emergency call requires LBR, the indication based on a serving cell for the UE, which may be, e.g., memory 610, the external interface 602 and one or more processors 604 with dedicated hardware or implementing executable code or software instructions in memory 610, such as the LBR required unit 612. A means for obtaining a first location estimate for the UE when the indication indicates the emergency call requires LBR, the first location estimate being more accurate than a location based on the serving cell, the first location estimate enabling LBR, the first location estimate obtained within a first response time may be, e.g., the external interface 602 and one or more processors 604 with dedicated hardware or implementing executable code or software instructions in memory 610, such as the first location estimate unit 614. A means for obtaining a second location estimate for the UE for delivery to the PSAP, the second location estimate obtained within a second response time, wherein the second location estimate is more accurate than the first location estimate, wherein the second response time exceeds the first response time may be, e.g., the external interface 602 and one or more processors 604 with dedicated hardware or implementing executable code or software instructions in memory 610, such as the second location estimate unit 616.

In one implementation, the network entity may further include a means for determining the indication of whether the emergency call requires LBR based on a cell database, wherein the indication is obtained based on the determined indication, which may be, e.g., the memory 610 and one or more processors 604 with dedicated hardware or implementing executable code or software instructions in memory 610, such as the LBR required unit 612.

In one implementation, the network entity may further include a means for sending a combined request for the first location estimate and the second location estimate to a location server, which may be, e.g., the external interface 602 and one or more processors 604 with dedicated hardware or implementing executable code or software instructions in memory 610, such as the request location estimate unit 613. A means for receiving a first response from the location server, the first response comprising the first location estimate may be, e.g., the external interface 602 and one or more processors 604 with dedicated hardware or implementing executable code or software instructions in memory 610, such as the first location estimate unit 614. A means for sending the first location estimate to a second network entity in a first message may be, e.g., the external interface 602 and one or more processors 604 with dedicated hardware or implementing executable code or software instructions in memory 610, such as the transmit location estimate unit 618. A means for receiving a second response from the location server, the second response comprising the second location estimate, the second response comprising the same message type as the first response may be, e.g., the external interface 602 and one or more processors 604 with dedicated hardware or implementing executable code or software instructions in memory 610, such as the second location estimate unit 616. A means for sending the second location estimate to the second network entity in a second message, the second message comprising the same message type as the first message may be, e.g., the external interface 602 and one or more processors 604 with dedicated hardware or implementing executable code or software instructions in memory 610, such as the transmit location estimate unit 618.

In one implementation, the network entity may be a location server and may include a means for receiving a first combined request for the first location estimate and the second location estimate from a second network entity, may be, e.g., the external interface 602 and one or more processors 604 with dedicated hardware or implementing executable code or software instructions in memory 610, such as the request location estimate unit 613. A means for sending a second combined request for the first location estimate and the second location estimate to the UE using a Long Term Evolution Positioning Protocol (LPP) may be, e.g., the external interface 602 and one or more processors 604 with dedicated hardware or implementing executable code or software instructions in memory 610, such as the request location estimate unit 613. A means for receiving a first LPP response from the UE, the first LPP response comprising the first location estimate may be, e.g., the external interface 602 and one or more processors 604 with dedicated hardware or implementing executable code or software instructions in memory 610, such as the first location estimate unit 614. A means for sending the first location estimate to the second network entity in a first response message may be, e.g., the external interface 602 and one or more processors 604 with dedicated hardware or implementing executable code or software instructions in memory 610, such as the transmit location estimate unit 618. A means for receiving a second LPP response from the UE, the second LPP response comprising the second location estimate, the second LPP response comprising the same LPP message type as the first LPP response may be, e.g., the external interface 602 and one or more processors 604 with dedicated hardware or implementing executable code or software instructions in memory 610, such as the second location estimate unit 616. A means for sending the second location estimate to the second network entity in a second response message, the second response message comprising the same message type as the first response message may be, e.g., the external interface 602 and one or more processors 604 with dedicated hardware or implementing executable code or software instructions in memory 610, such as the transmit location estimate unit 618.

In one implementation, the network entity may include a means for determining routing information for the emergency call based on the first location estimate, the routing information enabling routing of the emergency call to or towards the PSAP, which may be, e.g., the one or more processors 604 with dedicated hardware or implementing executable code or software instructions in memory 610, such as the routing information unit 620.

In one implementation, the network entity may include a means for receiving a location request for the UE from the PSAP, which may be, e.g., the external interface 602 and one or more processors 604 with dedicated hardware or implementing executable code or software instructions in memory 610, such as the location request unit 622. A means for sending a response to the PSAP, the response comprising the second location estimate may be, e.g., the external interface 602 and one or more processors 604 with dedicated hardware or implementing executable code or software instructions in memory 610, such as the location request unit 622.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method performed by a first network entity in a wireless network for supporting location based routing (LBR) of an emergency call for a user equipment (UE) to a Public Safety Answering Point (PSAP), the method comprising:
obtaining an indication of whether the emergency call requires LBR, the indication based on a serving cell for the UE;
obtaining a first location estimate for the UE when the indication indicates the emergency call requires LBR, the first location estimate being more accurate than a location based on the serving cell, the first location estimate enabling LBR, the first location estimate obtained within a first response time; and
obtaining a second location estimate for the UE for delivery to the PSAP, the second location estimate obtained within a second response time, wherein the second location estimate is more accurate than the first location estimate, wherein the second response time exceeds the first response time.

2. The method of claim 1, wherein the indication indicates the emergency call requires LBR when a coverage area for the serving cell for the UE overlaps coverage areas of at least two PSAPs.

3. The method of claim 1, wherein the indication indicates the emergency call requires LBR when a coverage area for the serving cell for the UE is within a threshold distance of a periphery of a coverage area of a PSAP.

4. The method of claim 1, wherein the emergency call is routed to the PSAP based on the serving cell, when the indication indicates the emergency call does not require LBR.

5. The method of claim 1, wherein the first location estimate is based on early location information provided by the UE using Long Term Evolution Positioning Protocol (LPP), wherein the second location estimate is based on final location information provided by the UE using LPP, wherein the first response time comprises an LPP ResponseTime responseTimeEarlyFix parameter and the second response time comprises an LPP ResponseTime time parameter.

6. The method of claim 1, wherein obtaining the indication of whether the emergency call requires LBR is based on a cell database.

7. The method of claim 1, further comprising:
sending a combined request for the first location estimate and the second location estimate to a location server;
receiving a first response from the location server, the first response comprising the first location estimate;
sending the first location estimate to a second network entity in a first message;
receiving a second response from the location server, the second response comprising the second location estimate, the second response comprising the same message type as the first response; and
sending the second location estimate to the second network entity in a second message, the second message comprising the same message type as the first message.

8. The method of claim 7, further comprising:
including the indication of whether the emergency call requires LBR in the combined request when the indication indicates the emergency call requires LBR.

9. The method of claim 7, wherein:
the first response includes an indication of an early location estimate, wherein the second response includes an indication of a final location estimate, wherein the first message includes an indication of the early location estimate, wherein the second message includes an indication of the final location estimate.

10. The method of claim 7, wherein the first network entity is a Mobility Management Entity (MME) or an Access and Mobility Management Function (AMF), the location server is an Evolved Serving Mobile Location Center (E-SMLC) or a Location Management Function (LMF), and the second network entity is a Gateway Mobile Location Center (GMLC).

11. The method of claim 1, wherein the first network entity is a location server, and further comprising:
receiving a first combined request for the first location estimate and the second location estimate from a second network entity;
sending a second combined request for the first location estimate and second location estimate to the UE using a Long Term Evolution Positioning Protocol (LPP);
receiving a first LPP response from the UE, the first LPP response comprising the first location estimate;
sending the first location estimate to the second network entity in a first response message;
receiving a second LPP response from the UE, the second LPP response comprising the second location estimate, the second LPP response comprising the same LPP message type as the first LPP response; and
sending the second location estimate to the second network entity in a second response message, the second response message comprising the same message type as the first response message.

12. The method of claim 11, wherein the second network entity is a Mobility Management Entity (MME), an Access and Mobility Management Function (AMF), or a Location Retrieval Function (LRF) and the location server is an Evolved Serving Mobile Location Center (E-SMLC), a Location Management Function (LMF), or a Secure User Plane Location (SUPL) Location Platform (SLP).

13. The method of claim 1, wherein obtaining the first location estimate comprises receiving the first location estimate from a second network entity, wherein obtaining the second location estimate comprises receiving the second location estimate from the second network entity.

14. The method of claim 13, further comprising:
determining routing information for the emergency call based on the first location estimate, the routing information enabling routing of the emergency call to or towards the PSAP.

15. The method of claim 13, further comprising:
receiving a location request for the UE from the PSAP; and
sending a response to the PSAP, the response comprising the second location estimate.

16. The method of claim 13, wherein the first network entity is a Location Retrieval Function (LRF) and the second network entity is a gateway mobile location center (GMLC) or a Secure User Plane Location (SUPL) Location Platform (SLP).

17. A network entity configured for supporting location based routing (LBR) of an emergency call for a user equipment (UE) to a Public Safety Answering Point (PSAP), the network entity being a first network entity in a wireless network, comprising:
an external interface configured to wirelessly communicate with other entities in the wireless network;
at least one memory;
at least one processor coupled to the external interface and the at least one memory, wherein the at least one processor is configured to:
obtain an indication of whether the emergency call requires LBR, the indication based on a serving cell for the UE;
obtain a first location estimate for the UE when the indication indicates the emergency call requires LBR, the first location estimate being more accurate than a location based on the serving cell, the first location estimate enabling LBR, the first location estimate obtained within a first response time; and
obtain a second location estimate for the UE for delivery to the PSAP, the second location estimate obtained within a second response time, wherein the second location estimate is more accurate than the first location estimate, wherein the second response time exceeds the first response time.

18. The network entity of claim 17, wherein the indication indicates the emergency call requires LBR when a coverage area for the serving cell for the UE overlaps coverage areas of at least two PSAPs.

19. The network entity of claim 17, wherein the indication indicates the emergency call requires LBR when a coverage area for the serving cell for the UE is within a threshold distance of a periphery of a coverage area of a PSAP.

20. The network entity of claim 17, wherein the emergency call is routed to the PSAP based on the serving cell, when the indication indicates the emergency call does not require LBR.

21. The network entity of claim 17, wherein the first location estimate is based on early location information provided by the UE using Long Term Evolution Positioning Protocol (LPP), wherein the second location estimate is based on final location information provided by the UE using LPP, wherein the first response time comprises an LPP ResponseTime responseTimeEarlyFix parameter and the second response time comprises an LPP ResponseTime time parameter.

22. The network entity of claim 17, wherein the at least one processor is configured to obtain the indication of whether the emergency call requires LBR based on a cell database.

23. The network entity of claim 17, wherein the at least one processor is further configured to:
send a combined request for the first location estimate and the second location estimate to a location server via the external interface;
receive a first response from the location server via the external interface, the first response comprising the first location estimate;
send the first location estimate to a second network entity in a first message via the external interface;
receive a second response from the location server via the external interface, the second response comprising the second location estimate, the second response comprising the same message type as the first response; and
send the second location estimate to the second network entity in a second message via the external interface, the second message comprising the same message type as the first message.

24. The network entity of claim 23, wherein the at least one processor is further configured to:
include the indication of whether the emergency call requires LBR in the combined request when the indication indicates the emergency call requires LBR.

25. The network entity of claim 23, wherein:
the first response includes an indication of an early location estimate, wherein the second response includes an indication of a final location estimate, wherein the first message includes an indication of the early location estimate, wherein the second message includes an indication of the final location estimate.

26. The network entity of claim 23, wherein the first network entity is a Mobility Management Entity (MME) or an Access and Mobility Management Function (AMF), the location server is an Evolved Serving Mobile Location Center (E-SMLC) or a Location Management Function (LMF), and the second network entity is a Gateway Mobile Location Center (GMLC).

27. The network entity of claim 17, wherein the first network entity is a location server, and the at least one processor is further configured to:
receive a first combined request for the first location estimate and the second location estimate from a second network entity via the external interface;
send a second combined request for the first location estimate and the second location estimate to the UE using a Long Term Evolution Positioning Protocol (LPP) via the external interface;
receive a first LPP response from the UE via the external interface, the first LPP response comprising the first location estimate;
send the first location estimate to the second network entity in a first response message via the external interface;
receive a second LPP response from the UE via the external interface, the second LPP response comprising the second location estimate, the second LPP response comprising the same LPP message type as the first LPP response; and
send the second location estimate to the second network entity in a second response message via the external interface, the second response message comprising the same message type as the first response message.

28. The network entity of claim 27, wherein the second network entity is a Mobility Management Entity (MME), an Access and Mobility Management Function (AMF), or a Location Retrieval Function (LRF) and the location server is an Evolved Serving Mobile Location Center (E-SMLC), a Location Management Function (LMF), or a Secure User Plane Location (SUPL) Location Platform (SLP).

29. The network entity of claim 17, wherein the at least one processor is configured to obtain the first location estimate by being configured to receive the first location estimate from a second network entity, wherein the at least one processor is configured to obtain the second location estimate by being configured to receive the second location estimate from the second network entity.

30. The network entity of claim 29, wherein the at least one processor is further configured to:
determine routing information for the emergency call based on the first location estimate, the routing information enabling routing of the emergency call to or towards the PSAP.

31. The network entity of claim 29, wherein the at least one processor is further configured to:
receive a location request for the UE from the PSAP; and
send a response to the PSAP, the response comprising the second location estimate.

32. The network entity of claim 29, wherein the first network entity is a Location Retrieval Function (LRF) and the second network entity is a gateway mobile location center (GMLC) or a Secure User Plane Location (SUPL) Location Platform (SLP).

33. A network entity configured for supporting location based routing (LBR) of an emergency call for a user equipment (UE) to a Public Safety Answering Point (PSAP), comprising:
means for obtaining an indication of whether the emergency call requires LBR, the indication based on a serving cell for the UE;
means for obtaining a first location estimate for the UE when the indication indicates the emergency call requires LBR, the first location estimate being more accurate than a location based on the serving cell, the first location estimate enabling LBR, the first location estimate obtained within a first response time; and
means for obtaining a second location estimate for the UE for delivery to the PSAP, the second location estimate obtained within a second response time, wherein the second location estimate is more accurate than the first location estimate, wherein the second response time exceeds the first response time.

34. A non-transitory storage medium including program code stored thereon, the program code is operable to cause at least one processor in network entity in a wireless network to support location based routing (LBR) of an emergency call for a user equipment (UE) to a Public Safety Answering Point (PSAP), comprising:
program code to obtain an indication of whether the emergency call requires LBR, the indication based on a serving cell for the UE;
program code to obtain a first location estimate for the UE when the indication indicates the emergency call requires LBR, the first location estimate being more accurate than a location based on the serving cell, the first location estimate enabling LBR, the first location estimate obtained within a first response time; and
program code to obtain a second location estimate for the UE for delivery to the PSAP, the second location estimate obtained within a second response time, wherein the second location estimate is more accurate than the first location estimate, wherein the second response time exceeds the first response time.
